(19) United States
(12) Patent Application Publication
(10) Pub. No.: US 2009/0180238 A1
(43) Pub. Date: Jul. 16, 2009

(54) ENERGY STORAGE DEVICES

(75) Inventors: Roland Gallay, Farvagny-le-Petit (CH); Daniel Schlunke, Chatonnaye (CH)

Correspondence Address: Maxwell Technologies, Inc., 9244 Balboa Avenue, San Diego, CA, 92123, US

(73) Assignee: Maxwell Technologies, Inc., San Diego, CA (US)

(21) Appl. No.: 12/013,250

(22) Filed: Jan. 11, 2008

(51) Int. Cl. H01G 9/004

(52) U.S. Cl. 361/523; 438/239

(57) ABSTRACT

Double-layer energy storage devices and methods for manufacturing thereof are disclosed. Such devices and methods are useful for lessening self-discharge of the double-layer energy storage devices. An energy storage device and methods of manufacture that address the problem of capacitor self-discharge due to electrode misalignment, mismatch and/or unpaired electrodes is provided. The rate of self-discharge of a capacitor is increased when electrodes of electrode pairs are not well matched either by misalignment of the electrodes in one or more electrode pairs (e.g., along a longitudinal side or a terminal end of an electrode), or due to errors in the manufacture of electrodes where the electrodes of an electrode pair are not topographically matched (mismatch). In addition, self-discharge of a capacitor is increased if an unpaired electrode (an electrode without a counter-electrode) exists at the beginning, end or both of a roll or stack of capacitor units.

### BACKGROUND

This invention relates to improvements in energy storing or accumulating devices and methods of manufacture thereof.

Electrodes are widely used in many devices that store electrical energy, including primary (non-rechargeable) battery cells, secondary (rechargeable) battery cells, fuel cells, and capacitors. Important characteristics of electrical energy storage devices include energy density, power density, maximum charging rate, internal leakage current, self-discharge rates, equivalent series resistance, and durability, i.e., the ability to withstand multiple charge-discharge cycles. For a number of reasons, double layer capacitors—also known as supercapacitors and ultracapacitors—are gaining popularity in many energy storage applications. Reasons for this increased popularity include the recent availability of double layer capacitors with high power densities (in both charge and discharge modes), and with increased energy densities approaching those of conventional rechargeable battery cells.

A simple capacitor comprises a single capacitor “unit”: a first current collector, a first electrode, a second electrode (also known as a “counter-electrode” to the first electrode), a separator interposed between the first and second electrodes to ensure that the first and second electrodes do not come in contact with one another but that allows free flow of ions of the electrolyte, and a second current collector all immersed in an electrolytic solution. Double layer capacitors comprise from a few to thousands of these units in, e.g., a roll, stack or other multiplexed configuration.

When electric potential is applied across a pair of electrodes of a capacitor, ions that exist within the electrolyte are attracted to the surfaces of the oppositely-charged electrodes and migrate toward the electrodes. A layer of oppositely-charged ions is thus created and maintained near each electrode surface. Electrical energy is stored in the charge separation layers between these ionic layers and the charge layers of the corresponding electrode surfaces. The charge separation layers behave essentially as electrostatic capacitors.

One problem associated with double layer capacitors is a drop in voltage in the capacitor over time, commonly known as capacitor self-discharge or leakage current. Capacitor self-discharge can result in the loss of as much as 5% of a capacitor's energy per day.

The information included in this Background section of the specification, including any references cited herein and any description or discussion thereof, is included for technical reference purposes only and is not to be regarded subject matter by which the scope of the invention is to be bound.

### SUMMARY

Various embodiments are directed to electrodes, electrode assemblies, capacitors and electrical devices and methods of manufacture thereof that result in energy storage devices where problems with self-discharge are lessened, minimized or even eliminated.

Capacitor self-discharge causes a voltage drop at a terminal of a charged capacitor. The self-discharge typically occurs because electrons return to their most stable or balanced state, either by migrating through the separator (i.e., between electrodes having different charges), and/or moving around inside an electrode between areas of varying voltage or between easily accessible and more difficult to access portions of the electrode. This movement within an electrode occurs most commonly when: 1) electrodes of electrode pairs are not well matched either by misalignment of the two electrodes in the electrode pair (“misalignment”) or due to errors in the manufacture of electrodes, where the electrodes of an electrode pair are not topographically matched (“mismatched”); and/or 2) if an unpaired electrode (an electrode without a counter-electrode) exists at the beginning, end, or both the beginning and end of a roll or stack of capacitor units (“unpaired”).

An improved energy storage device and methods of manufacture that address the problem of capacitor self-discharge due to electrode misalignment, mismatch and/or unpaired electrodes is provided. The rate of self-discharge of a capacitor is increased when electrodes of electrode pairs are not well matched either by misalignment of the electrodes in one or more electrode pairs (e.g., along a longitudinal side or a terminal end of an electrode), or due to errors in the manufacture of electrodes where the electrodes of an electrode pair are not topographically matched (mismatch). In addition, self-discharge of a capacitor is increased if an unpaired electrode (an electrode without a counter-electrode) exists at the beginning, end or both of a roll or stack of capacitor units.

In one embodiment of a method, a first electrode, a second electrode and a separator are aligned. The separator is interposed between the first and second electrodes and forms an insulating layer separating the first and second electrodes. In a next step, mismatched or misaligned portions of the first and second electrodes are identified. Next, the mismatched or misaligned portions of the first and second electrodes are altered. Methods of altering the electrodes include removing active material from the misaligned or mismatched portion(s) of the electrodes, substantially removing all material from the misaligned or mismatched portion(s) of the electrodes, and/or preventing access to the misaligned or mismatched portions of the electrodes (e.g., applying a coating to substantially cover the misaligned or mismatched portion of the electrodes). It should be noted that only one electrode of an electrode pair may need to be altered, both electrodes of an electrode pair may need to be altered, or one or both electrodes of an electrode pair may need to be altered at more than one portion or location.

In yet another embodiment, unpaired electrodes are altered. First, unpaired electrodes—electrodes that are not paired with counter-electrodes—are identified. Next, one or more of the identified unpaired electrodes is altered. Alteration, for example, may include changing an electrode in order to reduce or eliminate a mismatch or misalignment, removing an unpaired electrode material, or preventing access to the unpaired electrode. Such alteration may include ablation of the one or more unpaired electrodes, coating the one or more unpaired electrodes, or by removing active portions of the one or more unpaired electrodes. Again, all unpaired electrodes may be altered, or only some unpaired electrodes may be altered.

Yet another exemplary embodiment provides an energy storage device comprising a first and a second current collector each having two opposing sides; a first electrode comprising a layer of active material disposed on each side of the opposing sides of the first current collector; a second electrode comprising a layer of active material disposed on each side of the opposing sides of the second current collector; a separator interposed between the first electrode and the second electrode; an electrolyte; and one or more altered portions of mismatched or misaligned portions of the first or second electrodes. The one or more altered mismatched or misaligned portions of the first and second electrodes may be altered by removing material from the mismatched or misaligned portions of the first and second electrodes or by preventing access to the misaligned or mismatched portions of the electrodes (e.g., coating the misaligned or mismatched portions of the first and second electrodes). All mismatched or misaligned portions of the electrodes may be altered, substantially all mismatched or misaligned portions may be altered, or only select mismatched or misaligned portions may be altered.

Yet another embodiment of an energy storage device includes more than one capacitor unit, wherein each unit comprises a first and a second current collector each having two opposing sides; a first electrode comprising a layer of active material disposed on each side of the opposing sides of the first current collector; a second electrode comprising a layer of active material disposed on each side of the opposing sides of the second current collector; a separator interposed between the first electrode and the second electrode; an electrolyte; and one or more altered portions of one or more unpaired first or second electrodes present in the capacitor units. The one or more altered unpaired electrodes may be altered by removing material from the unpaired electrodes or by preventing access to the misaligned or mismatched portions of the electrodes, such as by coating the unpaired electrodes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. It should also be understood that, although double layer implementations are described here, the described technology may be applied to other energy storage systems.

### BRIEF DESCRIPTION OF THE DRAWINGS

Illustrative embodiments are shown in the appended drawings.

FIG. 1 is illustrates a cross-sectional view of an electrode assembly of a stacked energy storage device.

FIGS. 2A-2D illustrate successive views of a rolled energy storage device in which the current collector components of the device are trimmed and connected to electrical terminals.

FIG. 2E illustrates a perspective view of a partially unrolled energy storage device where a portion of the energy storage device is unrolled and the layers of the electrode assembly are shown.

FIG. 3 illustrates a cross-sectional view of an electrode assembly of a rolled energy storage device such as that shown in FIGS. 2A-2E.

FIG. 4A illustrates a cross-sectional view of an electrode assembly having unpaired electrodes.

FIG. 4B illustrates a cross-sectional view of an electrode assembly, where the surface of the unpaired electrodes have been coated.

FIG. 5A illustrates a cross-sectional view of an energy storage device having an electrode pair that are not topographically matched.

FIG. 5B illustrates a cross-sectional view of an energy storage device, where one electrode of the electrode pair that was not topographically matched has been altered to provide symmetry to the electrode pair.

FIG. 6 illustrates one exemplary method for forming an energy storage device.

FIG. 7 illustrates yet another exemplary method for forming an energy storage device.

FIG. 8 is a graph of experimental data.

### DETAILED DESCRIPTION

Capacitors store energy in an electric field between a pair of closely spaced conductors or current collectors. When voltage is applied to the capacitor, electric charges of equal magnitude but opposite polarity build up on each current collector thereby storing energy. Double layer capacitors (also known in the art as ultracapacitors and supercapacitors) store electrostatic energy across an electrical potential formed between electrode pairs, where each electrode is associated with a current collector and where the electrodes of the electrode pair are separated by a separator. The entire assembly of the electrode pair, current collectors and separator (a single capacitor unit) is immersed in an electrolyte. When the capacitor unit is immersed in the electrolyte and charge is applied to the current collectors, a first layer of electrolyte dipole and a second layer of charged species are formed.

In comparison to conventional capacitors, double layer capacitors have high capacitance in relation to their volume and weight. There are two main reasons for these volumetric and weight efficiencies. First, the charge separation layers are very narrow in double layer capacitors, with widths typically on the order of nanometers. Second, electrodes can be made from a porous material, having very large effective surface area per unit volume. Because capacitance is directly proportional to electrode area and inversely proportional to the widths of the charge separation layers, the combined effect of the large effective surface area and narrow charge separation layers is capacitance that is very high in comparison to that of conventional capacitors of similar size and weight. The high capacitance of double layer capacitors allows the capacitors to receive, store, and release large amounts of electrical energy.

Self-discharge in double layer capacitors or other energy storage devices can lead to a gradual, steady, and sustained loss of voltage or energy over time. This loss of voltage or energy is generally due to the tendency of the electrons in the electrodes to migrate. Electrons may migrate, for example, between areas having different voltages (i.e. so as to equilibrate charge) or may migrate from a relatively easy to access portion of an electrode to a more difficult to access portion of the electrode (e.g., a portion of an electrode extending beyond an end of a current collector). Areas of different voltages or areas more difficult to access can be created—and thus the rate of self-discharge of a capacitor is increased—when electrodes of electrode pairs are not well matched either due to misalignment of the electrodes of the electrode pair due to manufacturing errors or errors introduced when arranging many electrode assemblies (for example, by stacking or rolling the assemblies), or due to mismatch in an electrode pair caused by errors in the manufacture of electrodes. In addition, self-discharge of a capacitor is increased if an unpaired electrode (an electrode without a counter-electrode) exists at the beginning, end, or both of a roll or stack of capacitor units.

Devices and methods for making devices that lessen, minimize or eliminate self-discharge in double layer capacitors are provided. Such methods generally include altering a misaligned or mismatched portion of one or both electrodes of an electrode pair that is misaligned with or is symmetrically or topographically mismatched with its counter-electrode in the electrode pair. In one method, active material is removed from a misaligned or mismatched portion(s) of one or both electrodes of an electrode pair, and in yet another method, substantially all of the misaligned or mismatched portion(s) of one or both electrodes of an electrode pair is removed. Another method includes preventing access to the misaligned or mismatched portions of the electrodes, such as by providing a coating to cover the misaligned or mismatched portion(s) of one or both electrodes of an electrode pair. Asymmetrical mismatches or mismatches between electrodes may happen at lateral and/or longitudinal edges of the double layer capacitors, particularly if they are stacked or wound and then flattened, or due to manufacturing errors. In many instances, such lateral and/or longitudinal mismatches or misalignments can be predicted due to methods used in the manufacturing process (e.g., predicted misalignment due to folding or rolling the electrode assemblies). In such instances, alteration of the electrodes of the double layer capacitors may be an integral part of the manufacturing process of energy storing devices.

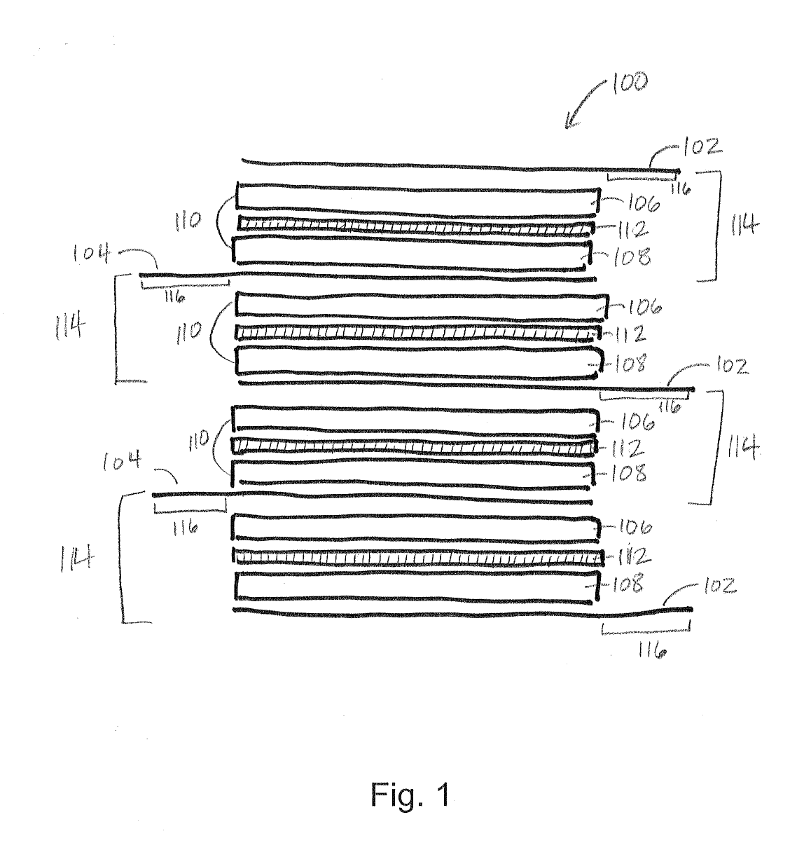

FIG. 1 illustrates a cross-sectional view of an electrode assembly 100 of a stacked energy storage device. The electrode assembly comprises a first electrode 106 and a second electrode 108 of an electrode pair 110, where the first electrode 106 is a counter electrode to the second electrode 108 and the second electrode 108 is a counter electrode of the first electrode 106. Interposed between the first electrode 106 and the second electrode 108 is a separator 112. The electrode assembly further comprises a first current collector 102 and a second current collector 104. The first and second current collectors 102 and 104 have extending portions 116 that are used to connect to an electrical terminal. A capacitor unit comprising a first current collector 102, a first electrode 106, a separator 112, a second electrode 108 and a second current collector 104 is indicated at 114.

The first and second electrodes 106 and 108 may be physically bonded to or coupled with current collectors 102 and 104. Any method of coupling known in the art may be used such as by utilizing an adhesive layer between the current collector and an electrode, by manufacturing electrodes out of a material that bonds to the current collector without the need for an adhesive, or by coating the electrode material onto the current collectors and then baking or pressing the combined current collector/electrode material together.

The first and second electrodes 106 and 108 may be made using particles of an active material, such as activated carbon and/or carbon black, which may be caked using PTFE as a binder. The active material enhances the conductivity of the electrodes. Alternatively, an activated carbon with a high soaking capacity or wettability may be selected for the electrodes, or a carbon with a high soaking capacity or wettability may be mixed with a carbon, graphite or nanotube material with, for example, particularly good capacitance characteristics, conductivity, low resistance, high voltage capacity or other desirable characteristics. Current collectors 102 and 104 may comprise any material known in the art as useful for current collectors, such as etched or roughened aluminum foil. Separator 112 may be made of materials known useful in the art, as long as separator 112 prevents first electrode 106 and second electrode 108 (i.e., electrodes of an electrode pair 110) from coming into contact with one another yet allows a free flow and ion exchange within the electrolyte between the electrode pair 110. Separators known in the art include those made from cellulose, porous polypropylene, polyethylene, PTFE or ceramic.

For example, in one exemplary embodiment, a capacitor unit 114 may comprise first and second current collectors 102 and 104 made of etched aluminum foil of about 30 microns in thickness, adhesive layers (not shown) to bond first and second electrodes 106 and 108 to the first and second current collectors 102 and 104 in a thickness of about 5 to 15 microns, first and second electrodes 106 and 108 made of, e.g., a dry blend of dry polytetrafluoroethylene (PTFE), such as TEFLON®, and dry activated, conductive carbon in a thickness of about 80 to about 250 microns, and a separator of porous polyethylene or polypropylene of a thickness of about 20 to about 40 microns.

The capacitor unit is immersed in an electrolyte solution, such as an organic solution. Organic electrolytes include propylene carbonate, acetonitrile, liquid crystal electrolytes, ionic liquid impregnants, and the like. Alternatively, gel-based electrolytes or solid electrolytes can be used, such as those formed by impregnating a solid matrix with electrolytic ions.

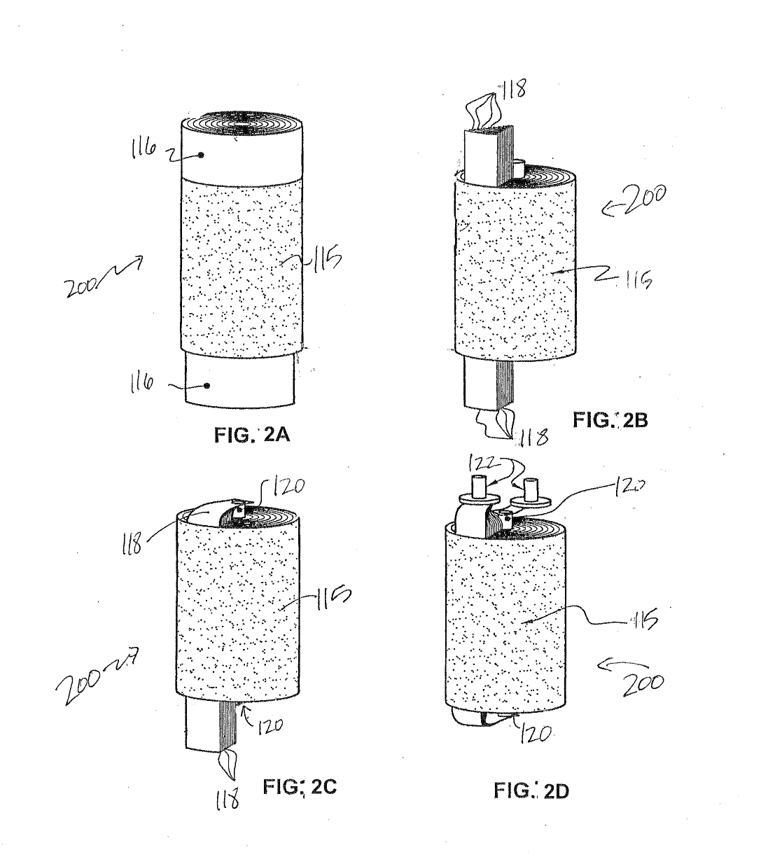

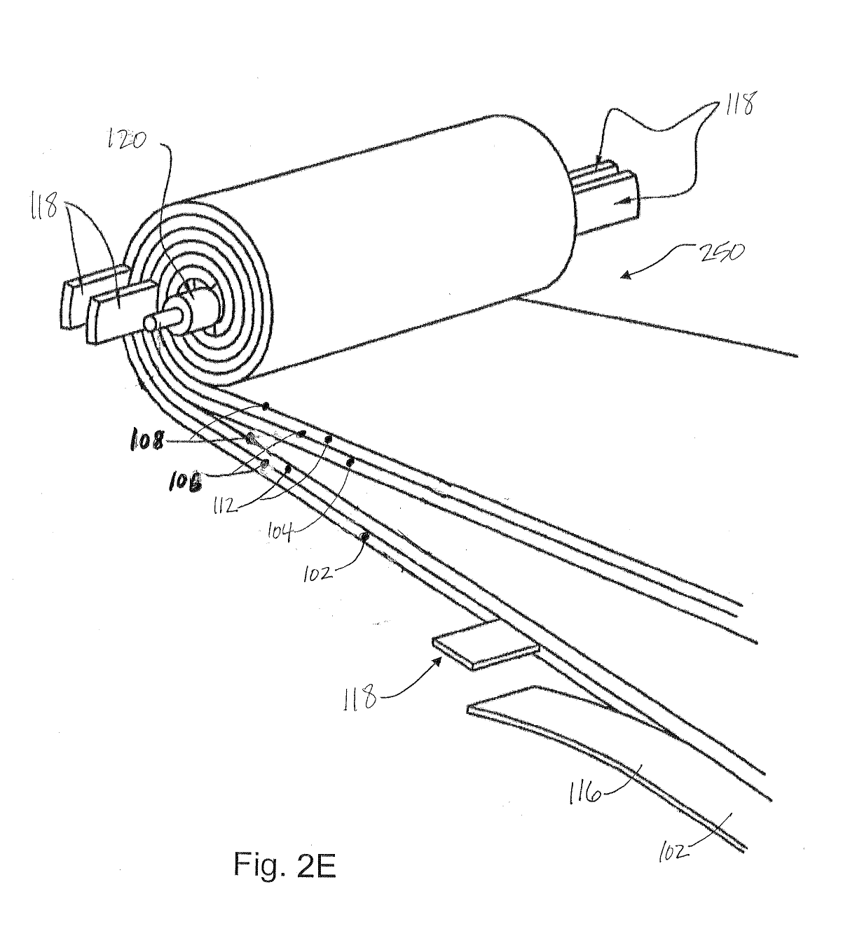

FIGS. 2A-2D illustrate successive views of a rolled energy storage device 200 in which the current collector components of the device are trimmed and connected to electrical terminals. FIG. 2A shows a rolled capacitor device where the extending portions 116 of current collectors 102 and 104 protrude beyond the main rolled portion 115 of rolled energy storage device 200. In FIG. 2B, the extending portions 116 of current collectors 102 and 104 have been trimmed resulting in current collector tabs 118. In FIG. 2C, the current collector tabs 118 are connected to a spindle 120, which is then connected to positive and negative electrical terminals 122 in FIG. 2D.

FIG. 2E illustrates a perspective view of a partially unrolled energy storage device 250 where a portion of the energy storage device is unrolled and the layers of the electrode assembly are shown. In FIG. 2E, first and second electrodes 106 and 108 are shown in two capacitor unit layers of the rolled energy storage device 250, separated by separators 112. The extending portion 116 of current collector 102 is shown being trimmed into current collector tabs 118. A spindle is shown at 120.

As can be seen in FIG. 2E, longitudinal ends of the first and second electrodes 106 and 108 may not be aligned or matched with each other at the spindle 120. Similarly, opposite longitudinal ends of the electrodes 106 and 108 at the external portion of the rolled energy storage device may also not be aligned or matched with each other. Each of these misaligned or mismatched portions provide locations in which electrons may migrate between easily accessible portions of the electrode (e.g., portions of the electrode having a counter electrode) and more difficult to access portions of the electrode (e.g., longitudinally end regions of an electrode that do not have a counter electrode disposed adjacently). Thus, as electrons migrate into an unpaired region located at a longitudinal end of the roll, self-discharge may occur.

In one implementation, the longitudinal ends of the electrodes may be aligned or altered to prevent access to a misaligned or mismatched portion of the electrodes during a manufacturing process of an energy storage device.

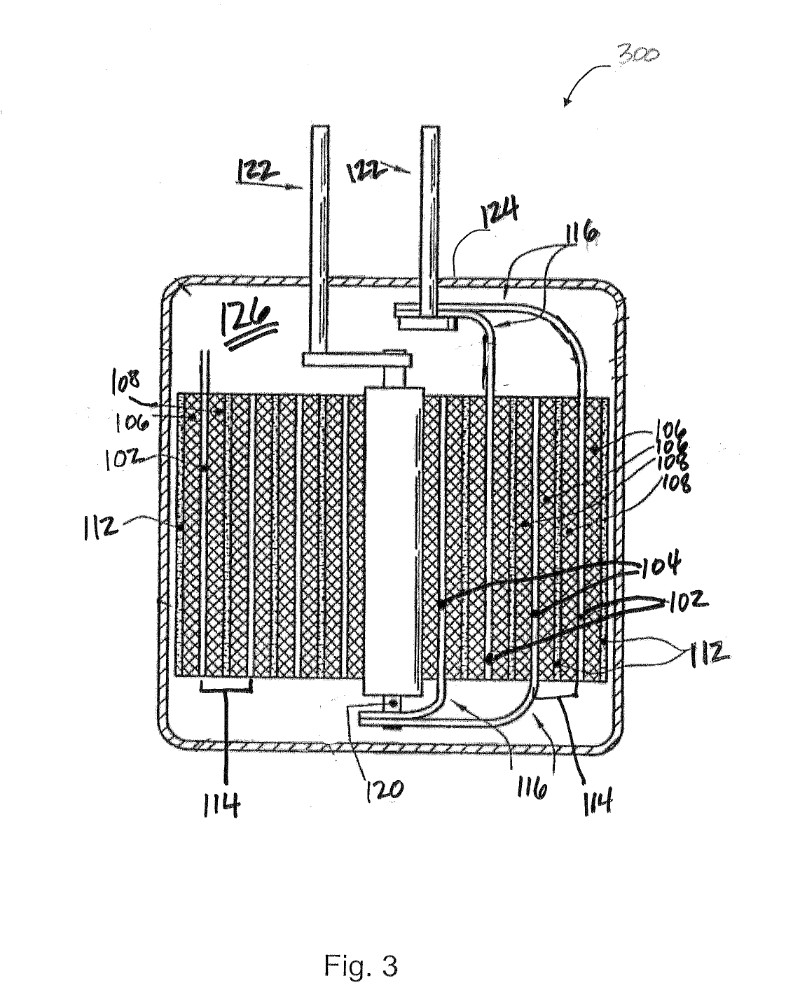

FIG. 3 illustrates a cross-sectional view of an electrode assembly of a rolled energy storage device 300 such as those shown in FIGS. 2A-2D. First and second current collectors are shown at 102 and 104, respectively, and first and second electrodes are shown at 106 and 108, respectively. Separators 112 are shown as well. A single capacitor unit is indicated at 114. Some of the extending portions 116 of current collectors 102 (toward the top of the rolled energy storage device 300) and 104 (toward the bottom of the rolled energy storage device 300) are shown. Spindle 120 is shown, as are terminals 122. In addition, a housing is shown in cross section at 124 and an electrolytic solution is indicated at 126.

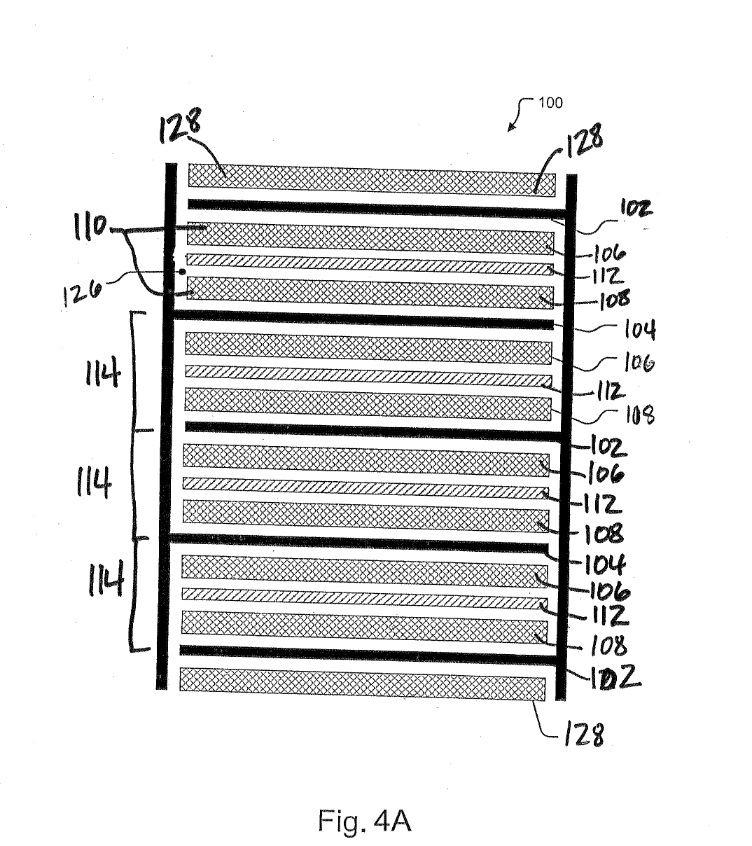

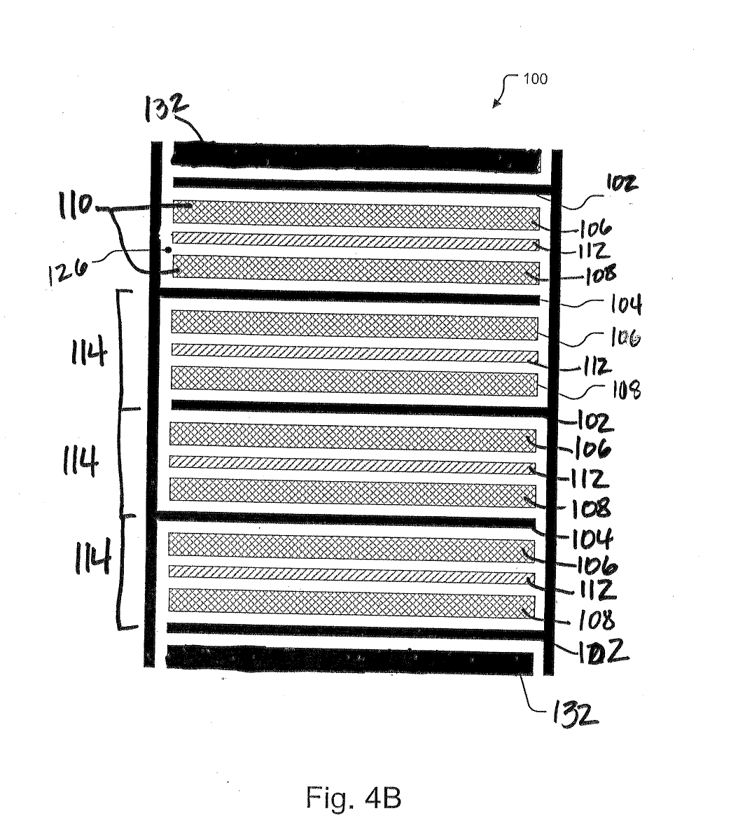

FIG. 4A illustrates a cross-sectional view of an electrode assembly 100 such as that shown in FIG. 1, having unpaired electrodes 128 on either end (top and bottom) of the electrode assembly. First and second current collectors are shown at 102 and 104, respectively, and first and second electrodes are shown at 106 and 108, respectively. Separators are shown at 112. A single capacitor unit is indicated at 114, and an electrolytic solution is indicated at 126. Unpaired electrodes 128 are considered unpaired because they do not have a corresponding counter-electrode and are not part of an electrode pair 110. Such unpaired electrodes result in an increased rate of self-discharge of a capacitor.

FIG. 4B illustrates a cross-sectional view of an electrode assembly, where the unpaired electrodes have been coated to prevent electron access to the unpaired electrode. Shown are first and second current collectors shown at 102 and 104, respectively, and first and second electrodes shown at 106 and 108, respectively. Separators 112 are shown as well. A single capacitor unit is indicated at 114, and electrolytic solution is indicated at 126. Unpaired electrodes 128 from FIG. 4A have been coated and the coated unpaired electrodes are indicated at 132. Useful coatings include virtually any inert substance compatible with the other materials used in the electrode assembly 100 (particularly the electrolyte shown at 126) and the energy storage device in general, including polymers such as methylate, parylene, polyamid imid, polypropylene, or parylene.

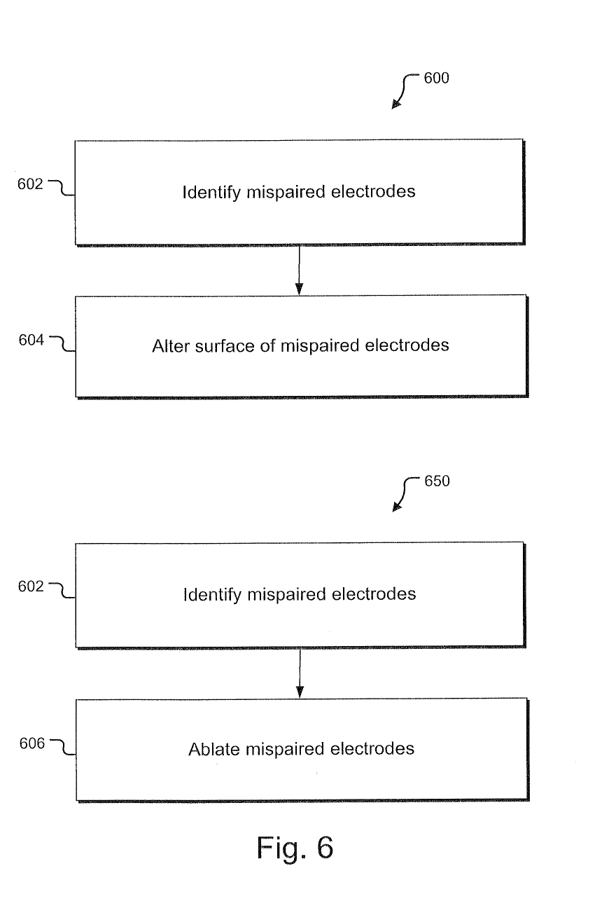

FIG. 6 illustrates one exemplary method for forming an energy storage device such as that shown in FIG. 4B. In this method, unpaired electrodes are identified 602. Again, unpaired electrodes are those electrodes that are not paired with a counter-electrode. Next, in step 602, one or more surfaces of the unpaired electrodes are altered. As described, one method of altering the surface of an electrode is by coating the surface of the electrode to prevent electron access to the unpaired electrode. However, in an alternative to coating, in electrodes that comprise an electrically active portion and a non-electrically active portion, altering may mean that only the electrically active portion of the electrode is altered, such as by stripping or ablation.

Alternatively, instead of coating the unpaired electrodes or ablating only active electrode material, the material forming the electrodes can be substantially ablated (removed) such as by mechanical stripping by polishing or scraping the surface of the electrode with a rotating device, by chemical means, or by a combination means such as by chemical mechanical polishing with a slurry and a rotating pad as is well known in the art. Method 650 shown in FIG. 6 shows this alternative. First, unpaired electrodes are identified 602. Next, the identified unpaired electrodes are ablated or removed 606.

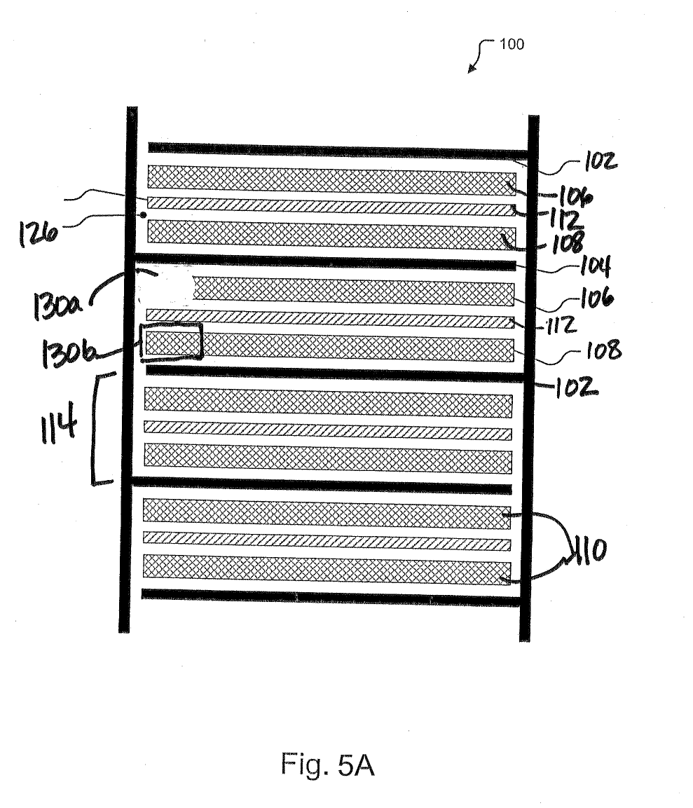

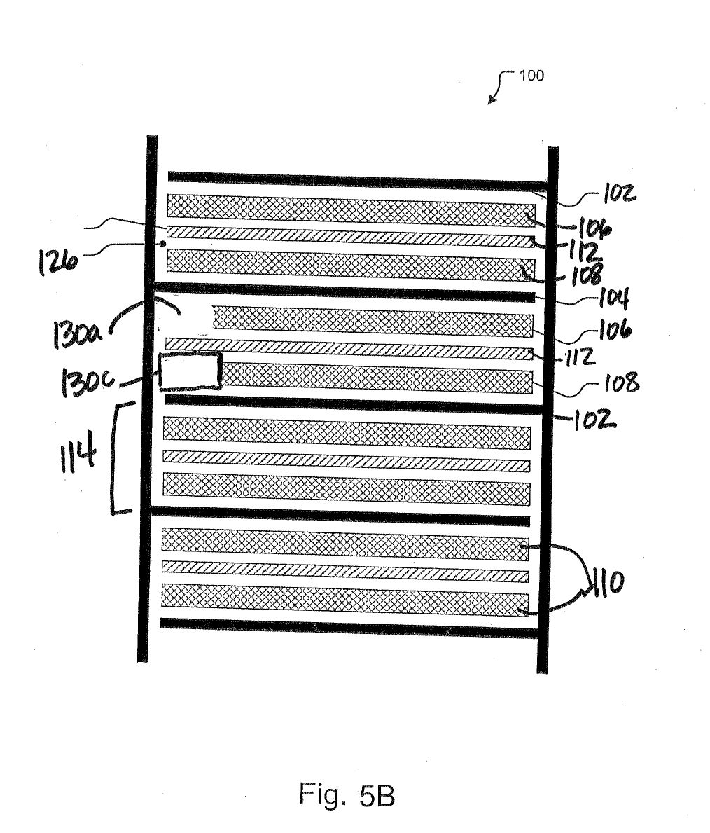

FIG. 5A illustrates a cross-sectional view of an electrode assembly having an electrode pair that are topographically mismatched. Again, first and second current collectors are shown at 102 and 104, respectively, and first and second electrodes are shown at 106 and 108, respectively. Separators 112 are shown as well, as is a single capacitor unit 114, an electrode pair 110, and electrolytic solution 126. Note that at 130a, the first electrode 106 of this electrode pair is missing electrode material, where at 130b, the second electrode 108 of this electrode pair has electrode material. Such a topographical mismatch of electrodes results in an increased rate of self-discharge of a capacitor.

FIG. 5B illustrates a cross-sectional view of an electrode assembly, where one electrode of the electrode pair that was not topographically matched at 130b has been ablated 130c to provide symmetry to the electrode pair. Again, first and second current collectors are shown at 102 and 104, respectively, and first and second electrodes are shown at 106 and 108, respectively. Separators 112 are shown, as is a single capacitor unit 114, an electrode pair 110, and electrolytic solution 126. Note that at 130a, first electrode 106 of this electrode pair is missing electrode material and, after ablation of a portion 130c of electrode 108, electrodes 106 and 108 of this electrode pair 110 are topographically matched.

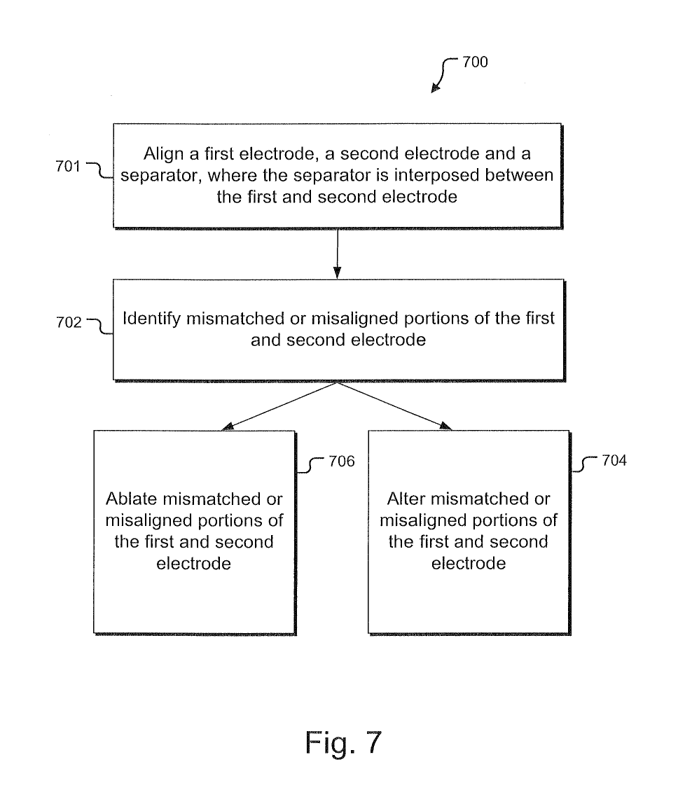

FIG. 7 illustrates one exemplary method 700 for forming an energy storage device such as that shown in FIG. 5B. In this method, first and second electrodes and a separator are aligned where the separator is interposed between the first and the second electrode 701. Next, mismatched or misaligned portions of the first and second electrode are identified 702. In step 706, mismatched or misaligned portions of the first and/or second electrodes are ablated. As described with unpaired electrodes, mismatched or misaligned portions of electrodes may be ablated by mechanical stripping by polishing or scrapping the surface of the electrode with a rotating device; by chemical means; or by a combination thereof such as by chemical mechanical polishing with a slurry and a rotating pad as is known in the art.

Alternatively, instead of ablating the mismatched or misaligned portions, the mismatched or misaligned portions of electrodes can be altered by other means (see steps 701, 702 and 704) for example by coating the mismatched or misaligned portions, or by partial ablation. Useful coatings include virtually any inert substance compatible with the other materials used in the electrode assembly 100 (particularly the electrolyte shown at 126) and the energy storage device in general, including polymers such as polyamidimide and polypropylene.

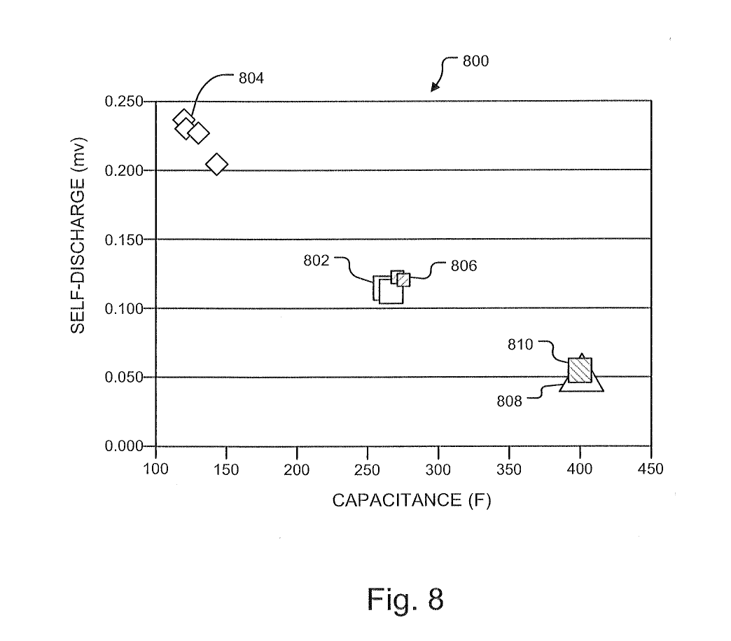

FIG. 8 illustrates a plot 800 of data points illustrating the impact of varying sizes and shifts of electrodes on the minimization of self-discharge in energy storage devices, plotting self-discharge (mV) versus capacitance (F). The data was collected and graphed for a number of samples by varying the widths and lengths of the electrodes and then testing and recording the self-discharge values in mV. A verification test was performed on a sample electrode having a capacitance of 100 F, which exhibited self-discharge of 0.048 mV, which is equal in value to that of a 2600 F standard BCAP0010 ultracapacitor, such as those available from Maxwell Technologies, Inc.

With continuing reference to FIG. 8, a first sample 802 included a 43 mm width negative electrode and a 27 mm width positive electrode. Note the different widths of the positive and negative electrodes in this sample. Specifically, there is a 16 mm difference in the widths of the positive and negative electrodes in the first sample 802, which is a mismatch or nonsymmetrical pairing of the electrodes and may result in significant self-discharge.

With continued reference to FIG. 8, a second sample 804 included a 27 mm width negative electrode and a 27 mm width positive electrode with a lateral shift between the electrodes of 40%. Note that the widths of the positive and negative electrodes in this sample are the same, but there is a significant 40% difference in the lateral shift of the electrodes. This 40% lateral shift is a form of mismatch or misalignment of the electrodes, which may result in significant self-discharge. Lateral shift may be caused by imprecision of the winding, rolling or stacking process during formation of a rolled energy storage device (described above) or due to manufacturing errors in aligning or forming the electrodes.

A third sample 806 included a 43 mm width negative electrode and a 43 mm width positive electrode with a longitudinal shift between the electrodes of 25%. Note that the widths of the positive and negative electrodes in this sample are the same, but there is a significant 25% difference in the longitudinal shift of the electrodes. This 25% longitudinal shift is a form of a mismatch or misalignment of the electrodes, which may result in significant self-discharge. This longitudinal shift is present at both the beginning and end of the winding process used to form a rolled energy storage device. Longitudinal shift becomes a larger problem at the end of the winding process because of the longer length of the last or most external layers of electrodes.

A mismatch or misalignment at a lateral edge of an electrode may induce a voltage drop due to self-discharge of the energy storage cell in a relatively short period of time (e.g., minutes to hours scale) since electrons in the electrodes may migrate to an unpaired portion of the electrode resulting in a voltage drop relatively quickly. A mismatch or misalignment at a longitudinal end of an electrode may, however, induce a voltage drop in a relatively longer time period (e.g., hours to days scale). By eliminating a redistribution of electrons into a relatively difficult portion of the electrode to access, a voltage drop due to self-discharge may be reduced.

A fourth sample 808 and a fifth sample 810 included a 43 mm width negative electrode and a 43 mm width positive electrode without any shift between the electrodes. Note that the widths of the positive and negative electrodes in these example samples are the same and there is no shift between the electrodes. Thus, there is little or no mismatch or nonsymmetrical pairing of the electrodes, which will result in minimal self-discharge.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for producing an energy storage device, comprising:
aligning a first electrode, a second electrode, and a separator, said separator interposed between said first electrode and said second electrode;
identifying a mismatched or misaligned portion of said first electrode; and
altering the mismatched or misaligned portion of said first electrode.

2. The method of claim 1, wherein altering said mismatched or misaligned portions of said first electrode comprises removing material from said mismatched or misaligned portion of said first electrode.

3. The method of claim 2, wherein removing material from said mismatched or misaligned portion of said first electrode comprises removing an active material from said mismatched or misaligned portion of said first electrode.

4. The method of claim 2, wherein removing material from said mismatched or misaligned portion of said first electrode comprises removing substantially all material from said mismatched or misaligned portion of said first electrode.

5. The method of claim 1, wherein altering one or more of said mismatched or misaligned portion of said first electrode comprises reducing electron access to said mismatched or misaligned portion of said first electrode.

6. The method of claim 5, wherein reducing electron access to said mismatched or misaligned portion of said first electrode comprises applying a coating to substantially cover said mismatched or misaligned portion of said first electrode.

7. The method of claim 6, wherein said coating comprises an ion impermeable polymer.

8. The method of claim 6, wherein the ion impermeable polymer comprises at least one of: methylate, parylene, polyamid imid, polypropylene, or parylene.

9. The method of claim 1, further comprising identifying a mismatched or misaligned portion of said second electrode; and altering the mismatched or misaligned portion of said second electrode.

10. The method of claim 9, wherein altering said mismatched or misaligned portions of said second electrode comprises removing active material from said mismatched or misaligned portion of said second electrode.

11. The method of claim 9, wherein altering one or more of said mismatched or misaligned portion of said second electrode comprises applying a coating to substantially cover said mismatched or misaligned portion of said second electrode.

12. The method of claim 1 wherein the mismatched or misaligned portion of said first electrode comprises a lateral edge portion of said first electrode.

13. The method of claim 1 wherein the mismatched or misaligned portion of said first electrode comprises a longitudinal end portion of said first electrode.

14. A method of producing an energy storage device, comprising:
providing a first electrode and a second electrode on opposing sides of a first current collector;
providing a third electrode and a fourth electrode on opposing sides of a second current collector;
interposing a separator between said second electrode and said third electrode;
identifying an unpaired electrode; and
altering a surface said unpaired electrode.

15. The method of claim 14, wherein altering said unpaired electrode comprises removing material from said unpaired electrode.

16. The method of claim 15, wherein removing material from said unpaired electrode comprises removing an active material from said unpaired electrode.

17. The method of claim 15, wherein removing material from said unpaired electrode comprises removing substantially all material from said unpaired electrode.

18. The method of claim 14, wherein altering said unpaired electrode comprises reducing electron access to said unpaired electrode.

19. The method of claim 14, wherein altering said unpaired electrode comprises applying a coating to said surface of said unpaired electrode.

20. The method of claim 19, wherein altering said unpaired electrode comprises applying a coating to substantially cover said surface of said unpaired electrode.

21. The method of claim 19, wherein said coating comprises an ion impermeable polymer.

22. The method of claim 21, wherein the ion impermeable polymer comprises at least one of: methylate, parylene, polyamid imid, polypropylene, or parylene.

22. The method of claim 14 further comprising identifying a second unpaired electrode and altering a surface of said second unpaired electrode.

23. An energy storage device, comprising:
a first current collector and a second current collector each having two opposing sides;
a first electrode structure comprising a layer of active material disposed adjacent each side of said opposing sides of said first current collector;
a second electrode structure comprising a layer of active material disposed adjacent each side of said opposing sides of said second current collector; and
a separator interposed between said first electrode structure and said second electrode structure,
wherein a mismatched or misaligned portion of said first electrode structure is altered.

24. The energy storage device of claim 23, wherein said mismatched or misaligned portion of said first electrode structure has been altered by removing material from said mismatched or misaligned portion of said first electrode structure.

25. The energy storage device of claim 24, wherein said mismatched or misaligned portion of said first electrode structure has been altered by removing active material from said mismatched or misaligned portion of said first electrode structure.

26. The energy storage device of claim 24, wherein said mismatched or misaligned portion of said first electrode structure has been altered by removing substantially all active material from said mismatched or misaligned portion of said first electrode structure.

27. The energy storage device of claim 23, wherein said mismatched or misaligned portion of said first electrode structure has been altered by applying a coating to said mismatched or misaligned portion of said first electrode structure.

28. The energy storage device of claim 27, wherein said coating covers substantially all of said mismatched or misaligned portions of said first electrode structure.

29. The energy storage device of claim 27, wherein said coating comprises an ion impermeable polymer.

27. The energy storage device of claim 26, wherein the ion impermeable polymer comprises at least one of: methylate, parylene, polyamid imid, polypropylene, or parylene.

28. The energy storage device of claim 23 wherein the mismatched or misaligned portion of said first electrode structure comprises a lateral edge portion of said first electrode structure.

29. The energy storage device of claim 23 wherein the mismatched or misaligned portion of said first electrode structure comprises a longitudinal end portion of said first electrode structure.

30. An energy storage device, comprising:
a multiplexing of a plurality of adjacent capacitor units, wherein each of said capacitor units comprises:
a first current collector and a second current collector each having a pair of opposing sides,
a first electrode structure comprising a layer of active material disposed on each opposing side of said first current collector,
a second electrode structure comprising a layer of active material disposed on each opposing side of said second current collector, and
a separator interposed between the first electrode structure and the second electrode structure,
wherein at least one of the first electrode structures comprises an altered portion of an unpaired electrode.

31. The energy storage device of claim 30, wherein said altered portion of said unpaired electrode has been altered by removing material from said unpaired electrode.

32. The energy storage device of claim 31, wherein said altered portion of said unpaired electrode has been altered by removing active material from said unpaired electrode.

33. The energy storage device of claim 32, wherein said altered portion of said unpaired electrode has been altered by reducing moving substantially all material from said unpaired electrode.

34. The energy storage device of claim 30, wherein said altered portion of said unpaired electrode has been altered by reducing electron access to said unpaired electrode.

35. The energy storage device of claim 30, wherein said altered portion of said unpaired electrode has been altered by coating said unpaired electrode.

36. The energy storage device of claim 35, wherein said coating comprises an ion impermeable polymer.

37. The energy storage device of claim 36, wherein the ion impermeable polymer comprises at least one of: methylate, parylene, polyamid imid, polypropylene, or parylene.
